(19) United States
(12) Patent Application Publication
(10) Pub. No.: US 2026/0348471 A1
(43) Pub. Date: Nov. 5, 2026

(54) COMPOSITE SEAL UNIT, SEAL STRUCTURE, AND SEALING METHOD BY COMPOSITE SEAL UNIT

(71) Applicant: MITSUBISHI CABLE INDUSTRIES, LTD., Tokyo (JP)

(72) Inventors: Kota HIYAJI, Amagasaki-shi (JP); Satoshi TOUDOU, Amagasaki-shi (JP)

(73) Assignee: MITSUBISHI CABLE INDUSTRIES, LTD., Tokyo (JP)

(21) Appl. No.: 19/696,908

(22) Filed: Jun. 3, 2026

Related U.S. Application Data
(63) Continuation of application No. PCT/JP2024/039044, filed on Nov. 1, 2024.

(30) Foreign Application Priority Data
Jan. 16, 2024 (JP) 2024-004876
Aug. 1, 2024 (JP) 2024-125843

(51) Int. Cl. F16J 15/12

(52) U.S. Cl. CPC F16J 15/121

(57) ABSTRACT

A composite seal unit including an annular metal member in which a continuous recessed groove is formed over an entire periphery at an outer peripheral side or an inner peripheral side and an elastomer member including a housed portion that is fitted to the recessed groove of the metal member and a projecting portion that continues with the housed portion and on which a pair of flange portions abut is held between a pair of flange portions, only the projecting portion is caused to abut on the pair of flange portions when uncompressed and at start of compression, in a compressed state at a predetermined compression rate or more, the projecting portion and the deformed metal member are brought into contact with the pair of flange portions to seal between the pair of flange portions.

### CROSS-REFERENCE TO RELATED APPLICATIONS

This is a continuation of International Application No. PCT/JP2024/039044 filed on Nov. 1, 2024, which claims priority to Japanese Patent Application No. 2024-4876 filed on Jan. 16, 2024, and Japanese Patent Application No. 2024-125843 filed on Aug. 1, 2024. The entire disclosures of these applications are incorporated by reference herein.

### BACKGROUND

The present disclosure relates to a composite seal unit, a seal structure, and a sealing method by the composite seal unit.

Conventionally, in a semiconductor fabrication apparatus or a surface treatment apparatus for a liquid crystal panel, an o-ring made of rubber is used for creating a substantially vacuum environment. On the other hand, it has been known that, in a radical gas environment and a corrosive environment, the o-ring made of rubber is inferior in corrosion resistance and radical resistance, and therefore, a seal material including an elastic seal body and a corrosion-resistant ring made of fluororesin is used (for example, Japanese Patent No. 4625746).

However, similar to a rubber material, a resin material that coats the rubber material cannot avoid permeation of a gas, such as atmosphere or the like, from a high pressure side (atmosphere side) to a low pressure side (negative pressure side).

Thus, for example, as described in Japanese Unexamined Patent Publication No. 2023-156213, a low fastening force composite metal seal obtained by integrating a rubber o-ring with an outer peripheral side of a metal seal in a shape that can be inserted in an o-ring seal groove has been known. In the composite metal seal, flow of a high-temperature corrosive gas to a side of the rubber o-ring seal is reduced by a metal seal at an inner peripheral side as much as possible.

As described in Japanese Unexamined Patent Publication No. H11-201288, a gasket formed by providing a metal layer or a plastic layer on an inner peripheral surface and/or an outer peripheral surface of a ring-shaped rubber elastic body has been known. In the gasket, the metal layer or the plastic layer is bonded to the ring-shaped rubber elastic body.

### SUMMARY

### Technical Problem

In the composite metal seal, an elastic force of the composite metal seal is set substantially equal to an elastic force of the rubber o-ring seal. Supposedly, this configuration is made to make it possible to replace the known rubber o-ring seal with the composite metal seal.

There are needs for further increasing seal performance to a level higher than that of the known composite seal unit with a low fastening force as described above maintained.

In a configuration described in Japanese Unexamined Patent Publication No. H11-201288, since a recessed groove of the metal layer or the plastic layer is shallow, the metal layer or the plastic layer needs to be bonded to the ring-shaped elastic body and a labor for bonding treatment can be possibly a problem. On the other hand, without being bonded to the ring-shaped elastic body, the metal layer or the plastic layer is very easily separated from the ring-shaped elastic body, and thus, handling thereof is troublesome.

Similarly, also in a configuration described in Japanese Unexamined Patent Publication No. 2023-156213, the metal seal and the rubber o-ring seal are not bonded or like treatment has not been performed thereon, the metal layer or the plastic layer is easily separated from the ring-shaped elastic body, and thus, handling thereof is troublesome.

In view of the foregoing, the present disclosure has been devised, and it is therefore an object of the present disclosure to reduce penetration of a gas from an elastomer member and increase seal performance even while maintaining a fastening force low. It is another object of the present disclosure to, even while maintaining the fastening force low, reduce penetration of the gas from the elastomer member to increase the seal performance and also to cause separation to be less likely to occur and to facilitate handling.

### Solution to the Problem

In order to achieve the object described above, in the present disclosure, in a proper compressed state, while maintaining seal performance by an elastomer member, flow of a corrosive gas or a radical gas to a side of the elastomer member is suppressed by a metal member.

Specifically, according to a first aspect, a composite seal unit includes an annular metal member in which a continuous recessed groove is formed over an entire periphery at an outer peripheral side or an inner peripheral side and an elastomer member including a housed portion that is fitted to the recessed groove of the metal member and a projecting portion that continues with the housed portion and on which a pair of flange portions abut, only the projecting portion abuts on the pair of flange portions when uncompressed and at start of compression, the composite seal unit is configured such that, in a compressed state at a predetermined compression rate or more, the projecting portion and the deformed metal member contact the pair of flange portions to seal between the pair of flange portions, and the recessed groove of the metal member is configured such that both end portions thereof are caused to be closer to each other in an approaching direction, and thus, a smallest height dimension of the both end portions is smaller than a large height dimension of the housed portion.

According to the above-described configuration, while, as ensuring seal performance by the elastomer member, suppressing flow of a corrosive gas or a radical gas to a side of the elastomer member by the metal member in contact with the pair of flange portions in a compressed state, penetration of a gas (atmosphere) from the elastomer member can be reduced to increase the seal performance and also the elastomer member ensures the seal performance from a start of compression, so that a fastening force of the metal member can be reduced. Moreover, since the metal member and the elastomer member are less likely to be separated from each other, the metal member and the elastomer member are not deviated from each other when being held between the pair of flange portions, so that the seal performance can be properly exhibited.

According to a second aspect, in the first aspect, the housed portion when uncompressed has a semicircular or semielliptic cross section or includes a groove having a V-shaped cross section.

According to the above-described configuration, the housed portion is properly housed in the recessed groove of the metal member to be less likely to be separated from the recessed groove when uncompressed and when compressed.

According to a third aspect, in the first or second aspect, the recessed groove of the metal member covers the housed portion of the elastomer member over an entire periphery as both end portions thereof are caused to be closer to each other in an approaching direction and the housed portion is housed in the recessed groove to be less likely to be separated from the recessed groove when uncompressed and when compressed.

According to the above-described configuration, since the metal member and the elastomer member are less likely to be separated from each other, transportation after assembly is facilitated.

In a sealing method according to a fourth aspect, a composite seal unit including an annular metal member in which a continuous recessed groove is formed over an entire periphery at an outer peripheral side or an inner peripheral side and an elastomer member including a housed portion that is fitted to the recessed groove of the metal member and a projecting portion that continues with the housed portion and on which a pair of flange portions abut is held between the pair of flange portions, only the projecting portion is caused to abut on the pair of flange portions when uncompressed and at start of compression, the composite seal unit is configured such that, in a compressed state at a predetermined compression rate or more, the projecting portion and the deformed metal member are brought into contact with the pair of flange portions to seal between the pair of flange portions and penetration of a gas from the elastomer member is reduced while suppressing flow of a corrosive gas or a radical gas to a side of the elastomer member by the metal member, and the recessed groove of the metal member is molded in advance such that, as both end portions thereof are caused to be closer to each other in an approaching direction, the housed portion is housed in the recessed groove to be less likely to be separated from the recessed groove when uncompressed and when compressed.

According to the above-described configuration, while, as ensuring seal performance by the elastomer member, suppressing flow of a corrosive gas or a radical gas to the side of the elastomer member by the metal member in contact with the pair of flange portions in a compressed state, penetration of a gas from the elastomer member can be reduced and also the elastomer member ensures the seal performance from a start of compression, so that a fastening force of the metal member can be reduced. Moreover, since the metal member and the elastomer member are less likely to be separated from each other, the metal member and the elastomer member are not deviated from each other when being held between the pair of flange portions, so that the seal performance can be properly exhibited and transportation after assembly is facilitated.

According to a fifth aspect, in the fourth aspect, a side of the metal member is in a radical gas atmosphere.

According to the above-described configuration, in a compressed state, the metal member is in contact with the pair of flange portions to suppress flow of the radical gas to the side of the elastomer member from the metal member, and therefore, durability of the elastomer member is remarkably increased.

According to a sixth aspect, in the fourth or fifth aspect, the side of the elastomer member is used in an atmosphere of −80 °C or more and 250 °C or less.

According to the above-described configuration, selection of a wide range of the elastomer member from a low temperature to a high temperature is enabled.

According to a seventh aspect, a composite seal unit includes an annular metal member in which a continuous recessed groove is formed over an entire periphery at an outer peripheral side or an inner peripheral side and that is curved or bent such that both opening ends of the recessed groove are caused to be closer to each other and an annular elastomer member including a fitting portion that is fitted to the recessed groove of the metal member and a projecting portion that continues with the fitted portion via a neck portion with a smaller thickness than that of the fitting portion and on which a pair of flange portions abut, only the projecting portion abuts on the pair of flange portions when uncompressed and at start of compression, the composite seal unit is configured such that, in a compressed state at a predetermined compression rate or more, the projecting portion and the deformed metal member contact the pair of flange portions to seal between the pair of flange portions, a smallest distance between opposed portions of the opening ends of the metal member is smaller than a largest height of the fitting portion, and the opening ends of the metal member are engaged with the neck portion to prevent unintentional separation.

According to the above-described configuration, seal performance can be ensured by the elastomer member, flow of a corrosive gas or a radical gas to a side of the elastomer member can be suppressed by the metal member in contact with the pair of flange portions in a compressed state, penetration of a gas (atmosphere) from the elastomer member can be reduced to increase the seal performance and also the elastomer member ensures the seal performance from a start of compression, so that a fastening force of the metal member can be reduced. Moreover, a cross-sectional shape of the metal member is curved or bent such that portions thereof at the opening ends are caused to be closer to each other and the opening ends that are opposed to each other are engaged with the neck portion of the elastomer member to prevent unintentional separation, so that handling in fitting the composite seal unit to the seal groove or the like is extremely easy.

According to an eighth aspect, in the seventh aspect, in the compressed state, a curved portion of the metal member with an arc-shaped cross section abuts on the pair of flange portions.

According to above-described configuration, since the curved portion contacts the flange portions, an inner surface of a seal groove or the like is less likely to be damaged, as compared to when the metal member has a cross section with a pointed end portion.

According to a ninth aspect, in the seventh aspect, the smallest distance between opposed portions of the opening ends is equal to or more than 70% of a largest portion of the fitting portion and equal to or less than 99% of the largest portion of the fitting portion.

When the smallest distance between the opposed portions of the opening ends is less than 70% of the largest height of the fitting portion, the fitting portion is hard to be inserted between the opening ends, and when the smallest distance between the opposed portions of the opening ends is larger than 99% of the largest height of the fitting portion, the fitting portion is more likely to be separated unintentionally. According to the above-described configuration, however, the fitting portion is easily inserted between the opening ends and is less likely to come off once being inserted, so that the elastomer member does not come off from the metal member and handling is facilitated.

A seal structure according to a tenth aspect is a seal structure that exhibits seal performance in a state where the composite seal unit of any one of the seventh to ninth aspects is fitted to a recessed groove of a first member and is clamped by a second member, and a largest height of the metal member is larger than a depth of the recessed groove, is smaller than a largest height of the projecting portion, and is larger than 100% of the depth of the recessed groove and equal to or smaller than 130% of the recessed groove.

According to the above-described configuration, since the largest height of the metal member is moderately large with respect to the depth of the recessed groove, the projecting portion is compressed first, and then, the projecting portion together with the metal member is compressed at a proper compression rate.

According to an eleventh aspect, in the tenth aspect, the largest height of the projecting portion is equal to or larger than 105% of the depth of the recessed groove and equal to or smaller than 145% of the depth of the recessed groove.

When the largest height of the projecting portion is larger than 145% of the depth of the recessed groove, the compression rate of the projecting portion is increased too high, and when the largest height of the projecting portion is smaller than 105% of the depth of the recessed groove, the metal member is compressed in a state where the projecting portion is not sufficiently compressed. In the above-described configuration, however, the depth of the recessed groove is a moderate depth with respect to the largest height of the projecting portion, and thus, the seal performance is exhibited in a state where the elastomer member and the metal member are compressed at a proper compression rate.

In a sealing method according to a twelfth aspect, a composite seal unit including an annular metal member in which a continuous recessed groove is formed over an entire periphery at an outer peripheral side or an inner peripheral side and an annular elastomer member in which a fitting portion, a neck portion, and a projecting portion are continuously formed and that is configured such that the neck portion of the elastomer member is fitted to the recessed groove of the metal member to prevent unintentional separation is prepared, the composite seal unit is held between a pair of flange portions, only the projecting portion that continues with the fitting portion of the elastomer member via the neck portion abuts on the pair of flange portions when uncompressed and at start of compression, and in a compressed state at a predetermined compression rate or more, the projecting portion and a curved portion of the deformed metal member with an arc-shaped cross section are brought into contact with the pair of flange portions to seal between the pair of flange portions and to reduce penetration of a gas from the elastomer member while suppressing flow of a corrosive gas or a radical gas to a side of the elastomer member by the metal member.

According to the above-described configuration, the neck portion of the elastomer member is fitted to the recessed groove of the metal member to prevent unintentional separation, and thus, handling is easy when causing the composite seal unit to be held between the pair of flange portions. While, as ensuring seal performance by the elastomer member, suppressing flow of a corrosive gas or a radical gas to the side of the elastomer member by the metal member in contact with the pair of flange portions in a compressed state, penetration of a gas from the elastomer member can be reduced and also the elastomer member ensures the seal performance from a start of compression, so that a fastening force of the metal member can be reduced.

According to a thirteenth aspect, in the twelfth aspect, a side of the metal member is in a radical gas atmosphere.

According to the above-described configuration, in a compressed state, the metal member is in contact with the pair of flange portions to suppress flow of the radical gas to the side of the elastomer member from the metal member, and therefore, durability of the elastomer member is remarkably increased.

### Advantageous Effects of the Invention

As described above, according to the present disclosure, while maintaining the seal performance by the elastomer member and suppressing flow of a corrosive gas or a radical gas to the side of the elastomer member by the metal member, penetration of a gas from the elastomer member is reduced, so that, even while maintaining a fastening force low, the seal performance can be increased, separation can be caused to be less likely to occur, and handing can be facilitated.

### BRIEF DESCRIPTION OF THE DRAWINGS

FIG. 1 is an enlarged view of a section I of FIG. 2B illustrating a composite seal unit according to a first embodiment of the present disclosure.

FIG. 2A is a plan view illustrating the composite seal unit.

FIG. 2B is a cross-sectional view taken along the line IIb-IIb of FIG. 2A.

FIG. 3 is a cross-sectional view illustrating a state where an elastomer member and a metal member are compressed by a pair of flange portions to be deformed in finite element analysis.

FIG. 4 is a graph illustrating a relationship between a compression rate and a fastening force.

FIG. 5A is a cross-sectional view illustrating an example of a shape of the metal member.

FIG. 5B is a cross-sectional view illustrating another example of the shape of the metal member.

FIG. 5C is a cross-sectional view illustrating still another example of the shape of the metal member.

FIG. 5D is a cross-sectional view illustrating yet another example of the shape of the metal member.

FIG. 6A is a cross-sectional view illustrating an example of a shape of the elastomer member.

FIG. 6B is a cross-sectional view illustrating another example of the shape of the elastomer member.

FIG. 6C is a cross-sectional view illustrating still another example of the shape of the elastomer member.

FIG. 6D is a cross-sectional view illustrating yet another example of the shape of the elastomer member.

FIG. 7 is a graph illustrating a result of a helium leakage test.

FIG. 8 is a graph illustrating a result of a radical resistance test.

FIG. 9 is an enlarged cross-sectional view of a section IX of FIG. 10B illustrating a composite seal unit according to a second embodiment of the present disclosure.

FIG. 10A is a plan view illustrating the composite seal unit.

FIG. 10B is a cross-sectional view taken along the line XB-XB of FIG. 10A, illustrating the composite seal unit.

FIG. 10C is a perspective view illustrating the composite seal unit.

FIG. 10D is an end face view illustrating a seal structure before being compressed.

FIG. 11A is a cross-sectional view illustrating a state where an elastomer member and a metal member are in contact with a pair of flange portions, according to an analysis result in finite element analysis.

FIG. 11B is a cross-sectional view illustrating a state where an elastomer member and a metal member are compressed by a pair of flange portions to be deformed, according to an analysis result in finite element analysis.

FIG. 12 is a graph illustrating a relationship between a compression rate and a fastening force.

FIG. 13 is a cross-sectional view illustrating a composite seal unit according to a first modified example, corresponding to FIG. 9.

FIG. 14 is a cross-sectional view illustrating a composite seal unit according to a second modified example, corresponding to FIG. 9.

FIG. 15 is a cross-sectional view illustrating a composite seal unit according to a third modified example, corresponding to FIG. 9.

### DETAILED DESCRIPTION

Embodiments of the present disclosure will be described below with reference to the accompanying drawings.

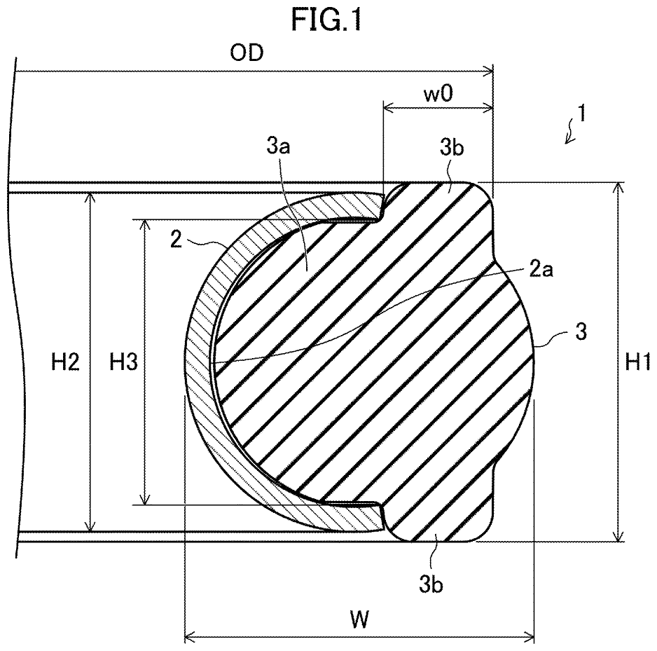

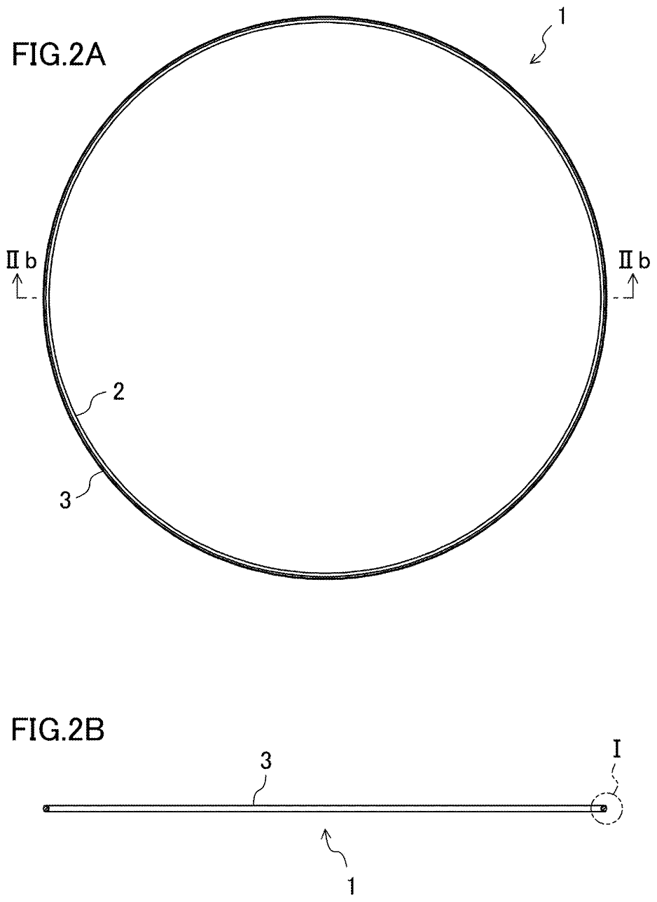

FIG. 1 to FIG. 2B illustrate a composite seal unit 1 of a first embodiment of the present disclosure, and the composite seal unit 1 includes an annular metal member 2 in which a continuous recessed groove 2a is formed over an entire periphery at an outer peripheral side.

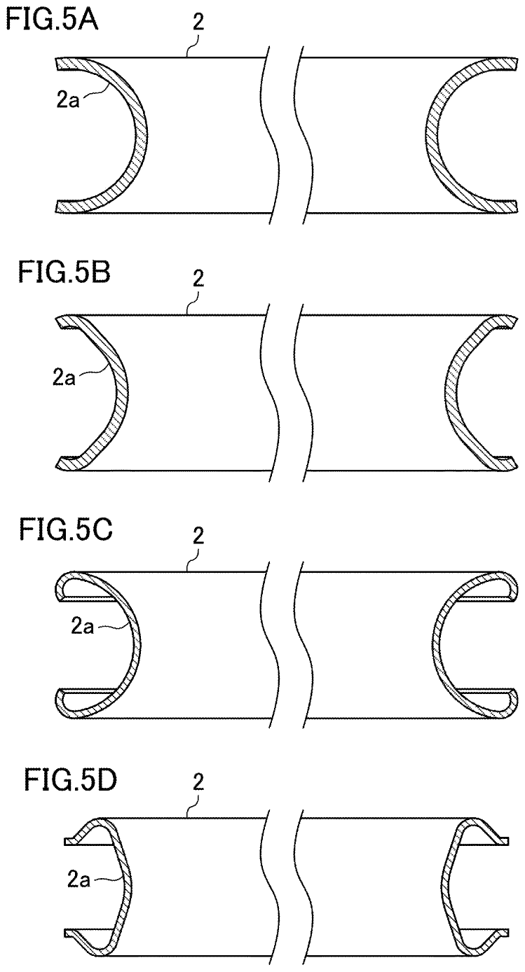

In the first embodiment, a cross section of the metal member 2 is in a substantially semicircular shape that opens to an outer periphery, but the metal member 2 may be in various shapes having the recessed groove 2a, as illustrated in FIG. 5A to FIG. 5D. The metal member 2 is formed of stainless steel (SUS316L, SUS304, or the like), nickel alloy (C22, C276, 718, or the like), titanium, aluminum alloy, copper alloy, or the like. The metal member 2 may be a molded article a thickness of which varies and may be a press molded article a plate thickness t of which is constant, or the like. The plate thickness t is 0.15 mm to 0.60 mm and is preferably 0.20 mm to 0.30 mm. A height H2 is 2 mm to 7 mm and is preferably 2.8 mm to 3.8 mm.

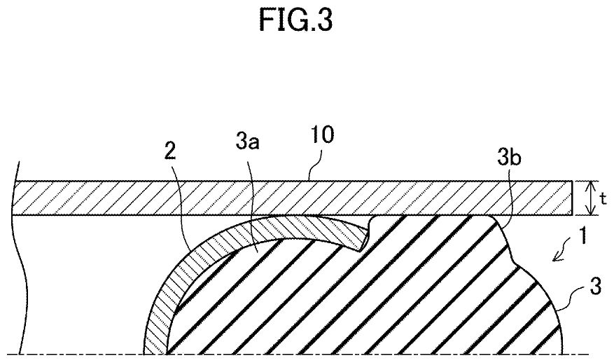

As also illustrated in FIG. 3, the composite seal unit 1 further includes an elastomer member 3 including a housed portion 3a that is fitted to the recessed groove 2a of the metal member 2 and a projecting portion 3b that continues with the housed portion 3a and on which a pair of flange portions 10 abut. The housed portion 3a of the elastomer member 3 when uncompressed is in a semicircular shape in the first embodiment.

In the first embodiment, the housed portion 3a is formed over an entire periphery at an inner peripheral side but, when the metal member 2 is provided at an outer peripheral side as will be described later in a second embodiment, the housed portion 3a may be provided at the outer peripheral side.

The elastomer member 3 is formed of silicone rubber, fluororubber, ethylene-propylene rubber, nitrile rubber, butyl rubber, acrylic rubber, SBR, chloroprene rubber, thermoplastic elastomer (TPE), or the like.

An outer diameter OD of the elastomer member 3 is 20 mm to 1270 mm and is preferably 300 mm to 700 mm, a height H1 is 2.2 mm to 7.5 mm and is preferably 3 mm to 4 mm. A width w0 of the projecting portion 3b in a radial direction is, for example, 1.1 mm but is not limited thereto. A width W of a cross section of the composite seal unit 1 in the radial direction is 2 mm to 12 mm and is preferably 2.5 mm to 4 mm.

As will be described in detail later, the height H2 of the metal member 2 when uncompressed is set to be lower than the height H1 of the elastomer member 3 (H2<H1) so that only the projecting portion 3b abuts on the pair of flange portions 10 when the composite seal unit 1 is uncompressed and at start of compression of the composite seal unit 1.

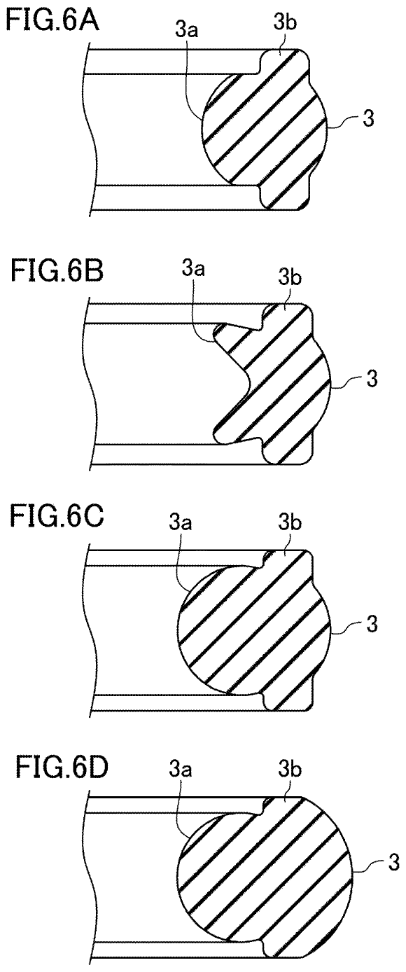

A smallest height dimension H3 between a pair of both end portions of the metal member 2 is preferably set such that the end portions are caused to be closer to each other in an approaching direction. The smallest height dimension H3 between the both end portions is preferably smaller than a largest height dimension of the housed portion 3a. In particular, when each of the metal portions illustrated in FIG. 5B to FIG. 5D is combined with a corresponding one of the elastomer members 3 illustrated in FIG. 6B to FIG. 6D, the above-described character notably appears.

As will be described in detailed later, the composite seal unit 1 is configured to seal between the pair of flanges 10 by bringing the projecting portion 3b and the deformed metal member 2 into contact with the pair of flange portions 10 in a compressed state at a predetermined compression rate or more.

The housed portion 3a when uncompressed is in a semicircular shape in the first embodiment, but may have a semielliptic cross section or have a shape including a groove with a V-shaped cross section, as illustrated in FIG. 6B to FIG. 6D.

### —Finite Element Analysis—

Analysis was performed on a relationship between compression rate and fastening force of the composite seal unit 1 using a finite element analysis software.

As for units, a length was in mm, a Young's modulus was in MPa, a force was in N. Based on static analysis and non-linear structure analysis (contact, large deformation), utilizing symmetry of the composite seal unit 1, analysis was performed on the composite seal unit 1 as a two-axis symmetric model illustrated in FIG. 3.

The pair of flange portions 10 having sufficiently high hardness with respect to the composite seal unit 1 was used, and the pair of flange portions 10 were treated as rigid bodies. In performing analysis including a deformation amount and contact with a friction, a large deformation effect was taken into consideration. The compression rate was calculated based on a height of the composite seal unit 1 when uncompressed, that is, the height H1 of the elastomer member when uncompressed.

In this analysis, for the elastomer member 3, a physical property value of silicone rubber having a Shore hardness of 70 A was used and, for the metal member 2, a physical property value of SUS316L was used.

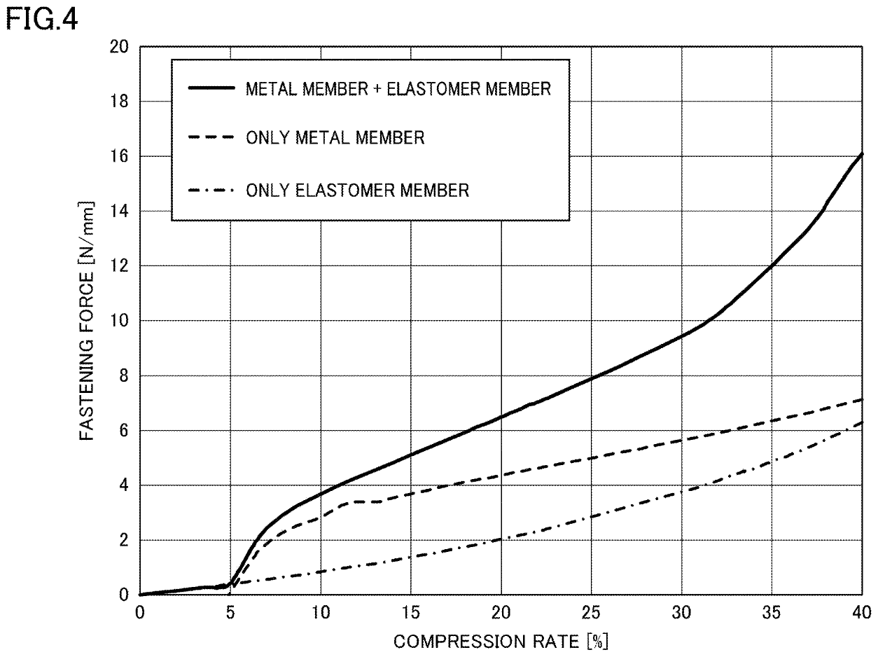

Since, as described above, the height H2 of the metal member 2 when uncompressed was set lower than the height H1 of the elastomer member 3 (H2<H1), as three lines given for a case where only the elastomer member 3 was provided, for a case where only the metal member 2 was provided, and a case where the composite seal unit 1 was provided indicate in FIG. 4, the metal member 2 started contacting the pair of flanges 10 at around a compression rate of 5%. It can be seen that the fastening force of the composite seal unit 1 rapidly increased around there. The seal performance was ensured by the elastomer member 3 from a start of compression.

That is, it is revealed that only upper and lower portions of the elastomer member 3 contacted the pair of flanges 10 at first and, at around a compression rate of 5%, an outer periphery of the metal member 2 also contacted the pair of flange portions 10.

The fastening force increased linearly at around a compression rate of 7.5%. It can be seen that, after 7.5%, both the metal member 2 and the elastomer member 3 were stably in contact with the pair of flanges to exhibit the seal performance.

When a target fastening force was reached, the compression rate was about 22% and a largest fastening force was 7.1 N/mm.

Similar analysis was performed for cases where the metal member 2 was in respective shapes illustrated in FIG. 5A to FIG. 5D and the elastomer member 3 was in a shape illustrated in FIG. 6A.

A relationship between a plate thickness and a height in each metal member and a fastening force when composited is illustrated in Table 1. With any one of the shapes, a proper fastening force was exhibited, as illustrated in Table 1. Examples illustrated in FIG. 3 and

FIG. 4 correspond to the cases in Table 1 (FIG. 5A to FIG. 5D). It was found that, with proper shape, proper plate thickness t, and height H2 of the metal member 2, a proper fastening force could be achieved.

TABLE 1

| | Plate | Metal member | Largest fastening |
|---|---|---|---|
| | thickness | height | force when |
| Shape | (mm) | h2 (mm) | composited (N/mm) |

| | | | | |
|---|---|---|---|---|
| A | 1 | 0.15 | 3.0 | 3.5 |
| | 2 | 0.25 | 3.0 | 6.2 |
| | 3 | 0.15 | 3.4 | 3.8 |
| | 4 | 0.25 | 3.4 | 7.1 |
| B | 1 | 0.15 | 3.0 | 3.9 |
| | 2 | 0.15 | 3.4 | 4.1 |
| | 3 | 0.25 | 3.4 | 8.3 |
| C | 1 | 0.15 | 3.2 | 3.9 |
| D | 1 | 0.15 | 3.0 | 6.4 |
| | 2 | 0.15 | 3.4 | 10.7 |

### —Sealing Method by Composite Seal Unit—

The composite seal unit 1 described above is held between the pair of flange portions 10. Although there is no particular limitation on a device that is used, for example, the method is used for a portion of a semiconductor fabrication apparatus or a surface treatment apparatus for a liquid crystal panel that connects a flow passage of a gas or a liquid and seals inside of the flow passage and outside of the flow passage in the pair of flange portions 10.

When uncompressed, only upper and lower projecting portions 3b of the elastomer member 3 are caused to abut on the pair of flange portions 10. In the first embodiment, for example, the composite seal unit 1 is used where an inner peripheral side of the metal member 2 (inside of the flow passage) is in a radical gas atmosphere and an outer peripheral side of the elastomer member 3 (outside of the flow passage) is in an atmosphere of −80 °C or more and 250 °C or less. Since the projecting portions 3b of the elastomer member 3 is in contact with the pair of flange portions 10 from a start of compression, the seal performance is reliably ensured.

Subsequently, when the compression rate is gradually increased, for example, as described above, the metal member 2 also starts abutting on the pair of flange portions 10 at around a compression rate of 5%, as illustrated in FIG. 3, and the projecting portions 3b and the deformed metal member 2 contact the pair of flange portions 10 in a compressed state at a compression rate of 5% or more.

Thus, the composite seal unit 1 seals between the pair of flange portions 10 with a proper fastening force to reduce penetration of a gas from the elastomer member 3 while suppressing flow of the radical gas to a side of the elastomer member 3 by the metal member 2.

The largest fastening force when compressed is preferably maintained, for example, at 3.9 N/mm or more and 25 N/mm or less. That is, the seal performance is secured by the flexible elastomer member 3, and therefore, the largest fastening force can be maintained at a low value, as compared to a metal seal of a simple substance.

As described above, while, as ensuring the seal performance by the elastomer member 3, suppressing flow of a radical gas to the side of the elastomer member 3 by the metal member 2 in contact with the pair of flange portions 10 in a compressed state, penetration of a gas from the elastomer member 3 can be reduced and the elastomer member 3 ensures the seal performance, so that the fastening force of the metal member 2 can be reduced.

In the compressed state, since the metal member 2 is in contact with the pair of flange portions 10 with a proper fastening force, flow of the radical gas to the side of the elastomer member 3 is effectively suppressed and durability of the elastomer member 3 is remarkably increased.

When an outer peripheral side of the elastomer member 3 is in an atmosphere at −80 °C or more and 250 °C or less, depending on applications, selection of a broad range of the elastomer member 3 as described above is enabled.

Furthermore, as both end portions of the recessed groove 2a are caused be closer to each other in an approaching direction, the recessed groove 2a of the metal member 2 covers the housed portion 3a of the elastomer member 3 over an entire periphery, and thus, the housed portion 3a is properly housed in the recessed groove 2a of the metal member 2 to be less likely to be separated from the recessed groove 2a when uncompressed and when compressed. Therefore, since the metal member and the elastomer member are less likely to be separated from each other, the metal member and the elastomer member are not deviated from each other even when the metal member and the elastomer member are held between the pair of flange portions, and the seal performance can be properly exhibited. Moreover, transportation after assembly is facilitated.

Therefore, according to the composite seal unit 1 according to the first embodiment, the seal performance is maintained by the elastomer member 3 and penetration of a gas from the elastomer member 3 is reduced while suppressing flow of a corrosive gas or a radical gas to the side of the elastomer member 3 by the metal member 2, so that the seal performance can be increased even while maintaining the fastening force low.

### —Confirmation of Effects by Helium Leakage Test—

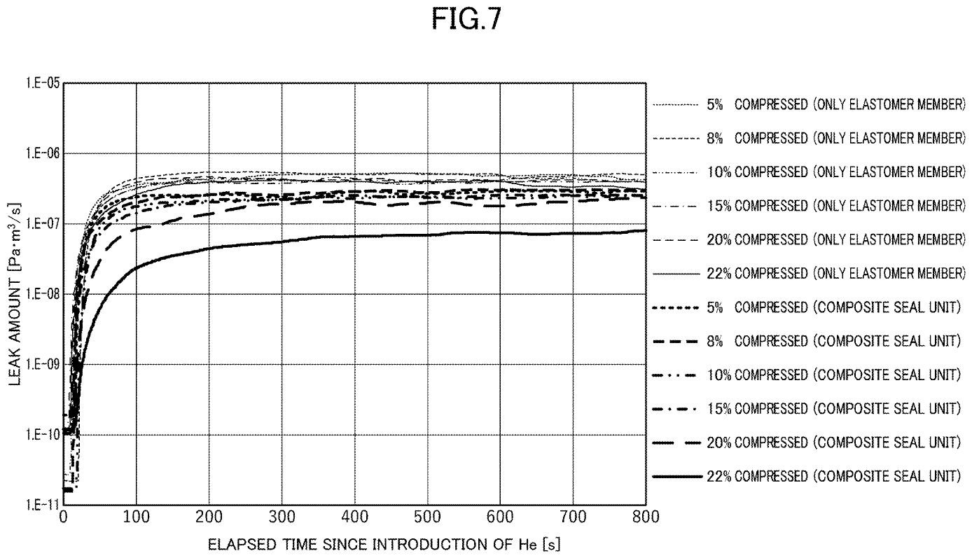

FIG. 7 is a graph illustrating a result of a helium leakage test using the composite seal unit 1 of the first embodiment of the present disclosure.

A test temperature was 22 °C, a flow rate of helium was 50 mL/min (a hood method), and a compression rate was set based on a seal initial height H1=3.60 mm.

Although details are not illustrated, the composite seal unit 1 was arranged between the pair of flange portions 10 of a pressing device and was thus compressed. A leak amount was monitored by a helium leak detector and a stable state was used as background. A tape was wound around outer peripheries of the pair of flange portions 10 to form a hood (with a helium inlet port left). A leak amount accumulated from a start of spraying helium to an inlet port was monitored for 10 minutes. The leak amount when the leak amount was stabled was recorded as a saturation leak amount.

As a comparative example, for a case where a corresponding seal including only the elastomer member 3 without the metal member 2 was provided, a leak amount was recorded in a similar manner.

As can be seen from FIG. 7, it was found that, in any one of cases where the compression rate was 10%, 20%, and 22%, the leak amount of the composite seal unit 1 was smaller, as compared to the case where the seal including only the elastomer member 3 was provided.

### —Confirmation of Effects by Radical Resistance Test—

Although not illustrated in the drawings, as a test machine, a radical exposure test machine was used. As for gas conditions, with O₂+CF₄ (2:1), a process chamber pressure was 100 Pa and a micro wave output was 2500 W. The compression rate was set based on H1=3.60 mm that is initial height of the composite seal unit 1.

A radical resistance effect was confirmed for the composite seal unit 1 and the seal including only the elastomer member 3 as a comparative example.

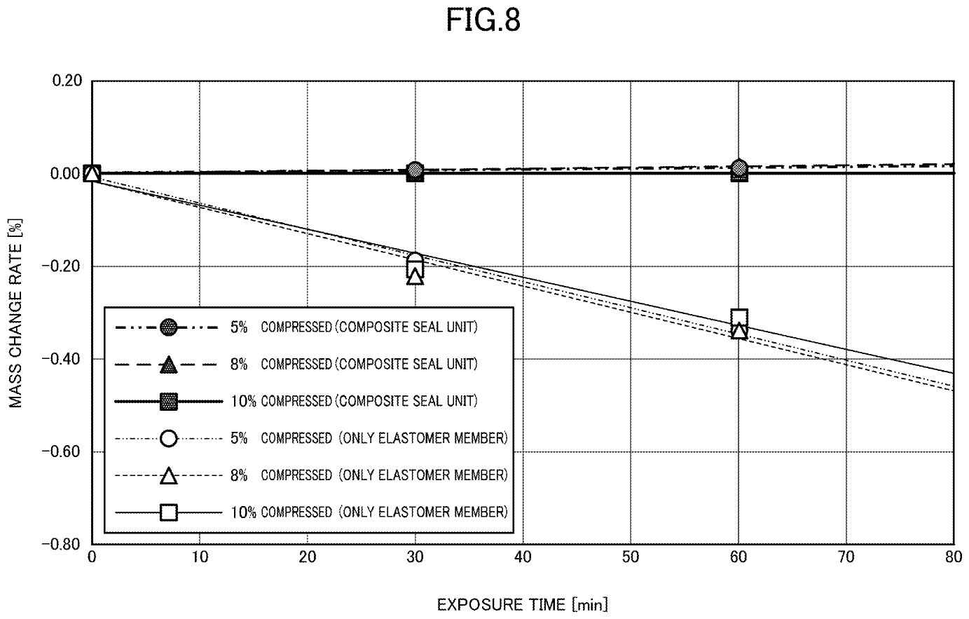

As illustrated in FIG. 8, in the composite seal unit 1, reduction in weight (consumption of the elastomer member 3) did not occur, and therefore, it was confirmed that compositing with the metal member 2 had an effect in radical resistance. On the other hand, for the case where only the elastomer member 3 was provided, it was found that consumption of the elastomer member notably occurred.

### Second Embodiment

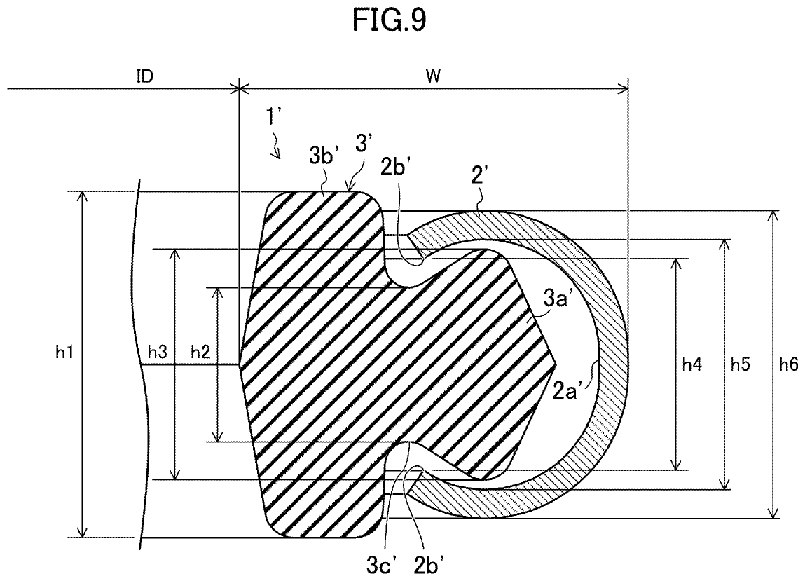

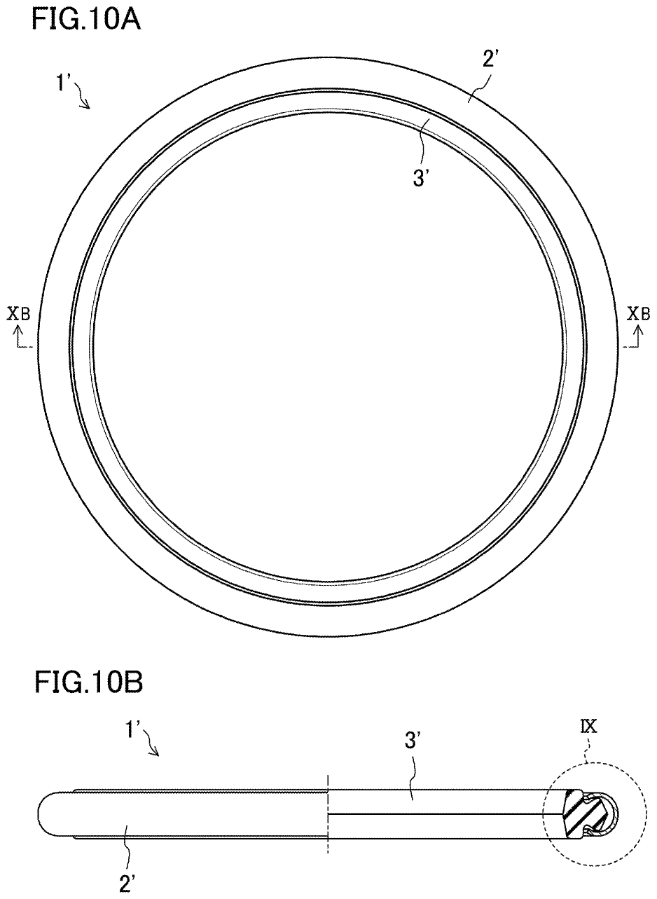

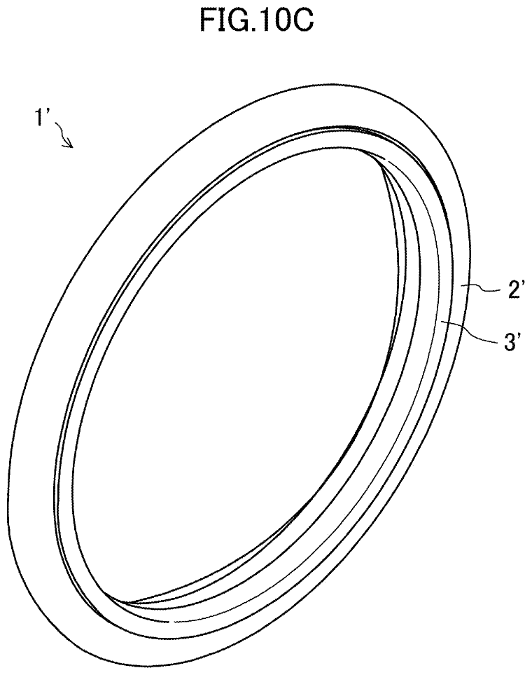

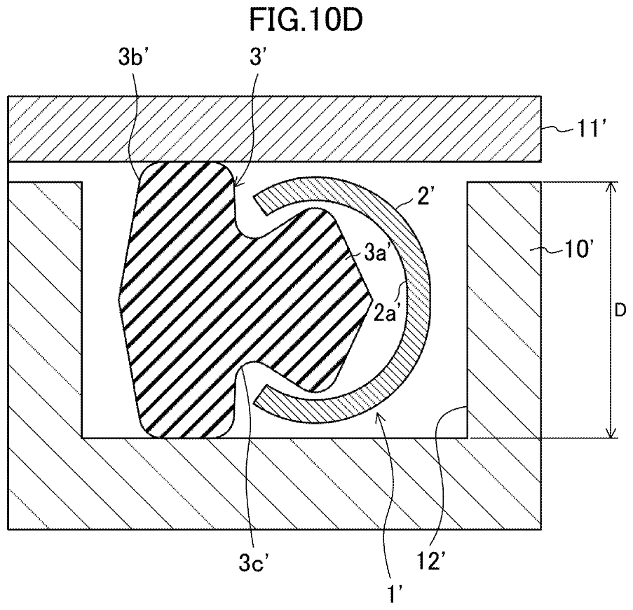

FIG. 9 and FIG. 10 illustrate a composite seal unit 1′ of a second embodiment of the present disclosure. While, in the first embodiment, the metal member 2 is provided at the inner peripheral side, the second embodiment corresponds to a case where the outer peripheral side is under an environment of a radical gas or the like and a metal member 2′ is provided at the outer peripheral side. In this case, an elastomer member 3′ is fitted to a recessed groove 2a′ at an inner peripheral side from the inner peripheral side.

The composite seal unit l′ includes the annular metal member 2′ in which the continuous recessed groove 2a′ is formed over an entire periphery at the outer peripheral side and that is curved such that opening ends 2b′ of the recessed groove 2a′ are caused to be closer to each other. A distance h4 between the pair of opening ends 2b′ is smaller than a largest height h5 of an inner periphery of the recessed groove 2a′ (h4<h5).

In the second embodiment, a cross section of the metal member 2′ is in a substantially semicircular shape that opens to an inner periphery, but the metal member 2 may be in various shapes having the recessed groove 2a′, as in a modified example that will be described later.

The metal member 2′ is formed of stainless steel (SUS316L, SUS304, or the like), nickel alloy (C22, C276, 718, or the like), titanium, aluminum alloy, copper alloy, or the like. The metal member 2 may be a molded article a thickness of which varies and may be a press molded article a plate thickness t of which is constant, or the like. The plate thickness tis 0.15 mm or more to 0.60 mm or less and is preferably 0.20 mm or more to 0.30 mm or less. A height h6 of the metal member 2′ is 1.2 mm or more to 7 mm or less and is preferably 1.8 mm or more to 3.8 mm or less. A largest height of the inner periphery of the recessed groove 2a′ is expressed by h5=h6−2×t(h4<h5<h6).

The composite seal unit 1′ further includes an elastomer member 3′ including a fitting portion 3a′ that is fitted to the recessed groove 2a′ of the metal member 2′ and a projecting portion 3b′ that continues with the fitting portion 3a′ with a neck portion 3c′ a thickness of which is smaller than that of the fitting portion 3a′ and on which a pair of flange portions 10′ and 11′ (illustrated only in FIG. 10D) as a first member and a second member abut. The fitting portion 3a′ of the elastomer member 3′ when uncompressed is in a semicircular shape in the second embodiment.

In the second embodiment, the fitting portion 3a′ is formed over an entire periphery at an outer peripheral side but, when the metal member 2′ is provided at an inner peripheral side as in the first embodiment, the fitting portion 3a′ may be provided at the inner peripheral side.

The elastomer member 3′ is formed of silicone rubber, fluororubber, ethylene-propylene rubber, nitrile rubber, butyl rubber, acrylic rubber, SBR, chloroprene rubber, thermoplastic elastomer (TPE), or the like.

An inner diameter ID of the elastomer member 3′ is 20 mm to 1270 mm and is preferably 300 mm to 700 mm, and a largest height h1 is 1.5 mm to 7.5 mm and is preferably 2.5 mm to 4 mm. A compression rate Ahl of the elastomer member 3′ is basically equal to or more than 5% of h1 and equal to or less than 30% of h1. As illustrated in FIG. 10D, a groove depth D is equal to or more than 70% of the largest height h1 of the elastomer member and equal to or less than 95% of the largest height h1 of the elastomer member (0.70h1≤D≤0.95h1) and is preferably equal to or more than 75% of the largest height h1 of the elastomer member and equal to or less than 85% of the largest height h1 of the elastomer member (0.75h1≤D≤0.85h1). A width W of a cross section of the composite seal unit l′ in the radial direction is 2 mm to 12 mm and is preferably 2.5 mm to 6 mm. When it is assumed that a depth of a seal groove 12′ formed in a first flange portion 10′ is D, the height h6 of the metal member 2′ is equal to or larger than the depth D of the seal groove 12′ and smaller than the largest height h1 of the elastomer member 3 (D≤h6<h1). The height h6 of the metal member 2′ is larger than 100% of the groove depth D and equal to or less than 120% of the groove depth D (D<h6≤1.2D).

A height h2 of the neck portion 3c′ of the elastomer member 3′ is smaller than the largest height h3 of the fitting portion 3a′ and is smaller than the distance h4 between the opening ends 2b′ of the metal member 2′ (h2<h4<h3). It is preferable to ensure a proper space between each of the opening ends 2b′ and the neck portion 3c′ (0.75h4≤h2≤0.9h4) so that an excessive force is not applied on the elastomer member 3′ from the metal member 2′ when compressed. The distance h4 between the opening ends 2b′ is preferably equal to or more than 90% of the largest height h1 of the elastomer member 3′ and equal to or less than 99% of the largest height h1 of the elastomer member 3′ (0.9h3≤h4≤0.99h3).

As will be described in detail later, the height h6 of the metal member 2′ when uncompressed is set to be lower than the height h1 of the elastomer member 3′ (h6<h1) such that only the projecting portion 3b′ abuts on the pair of flange portions 10′ and 11′ when the composite seal unit l′ is uncompressed and at start of compression of the composite seal unit. In a state where the composite seal unit l′ is compressed, h3≤h5 is satisfied and, preferably, h3≤h5≤1.1h3 is satisfied such that the elastomer member 3′ is not compressed by the metal member 2′. To summarize, a relationship between the heights of the metal member 2′ and the elastomer member 3′ is expressed by h2<h4<h3≤h5<h6<h1.

As will be described in detail later, in a compressed state at a predetermined compression rate or more, the projecting portion 3b′ and the deformed metal member 2′ contact the pair of flange portions 10′ and 11′ to seal between the pair of flange portions 10′ and 11′.

The fitting portion 3a′ when uncompressed has a semicircular cross section in the second embodiment, but may have a cross section in a different shape as will be described in a modified example.

### —Finite Element Analysis—

Analysis was performed on a relationship between compression rate and fastening force of the composite seal unit l′ using a commercially available finite element analysis software.

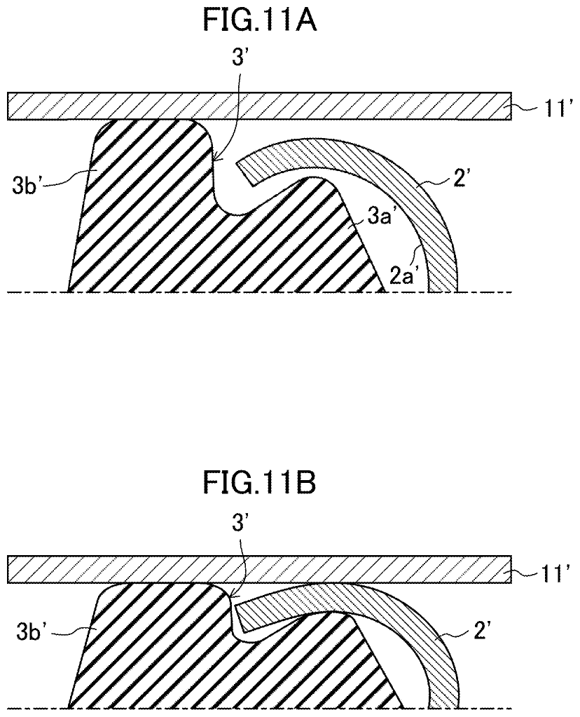

Based on static analysis and non-linear structure analysis (contact, large deformation), utilizing symmetry of the composite seal unit 1′, analysis was performed on the composite seal unit 1′ as a ½-axis symmetric model illustrated in FIG. 11A and FIG. 11B.

For a deformation amount of the composite seal unit 1′, a deformation amount of the pair of flange portions 10′ and 11′ was sufficiently small, hardness of the pair of flange portions and 11′ was sufficiently high, and thus, the pair of flange portions 10′ and 11′ were treated as rigid bodies. In performing analysis including a deformation amount and contact with a 10 friction, a large deformation effect was taken into consideration. The compression rate was calculated based on a height of the composite seal unit l′ when uncompressed, that is, the height h1 of the elastomer member 3′ when uncompressed.

In this analysis, for the elastomer member 3′, a physical property value of silicone rubber having a Shore hardness of 70 A was used and, for the metal member 2′, a physical property value of SUS316L was used.

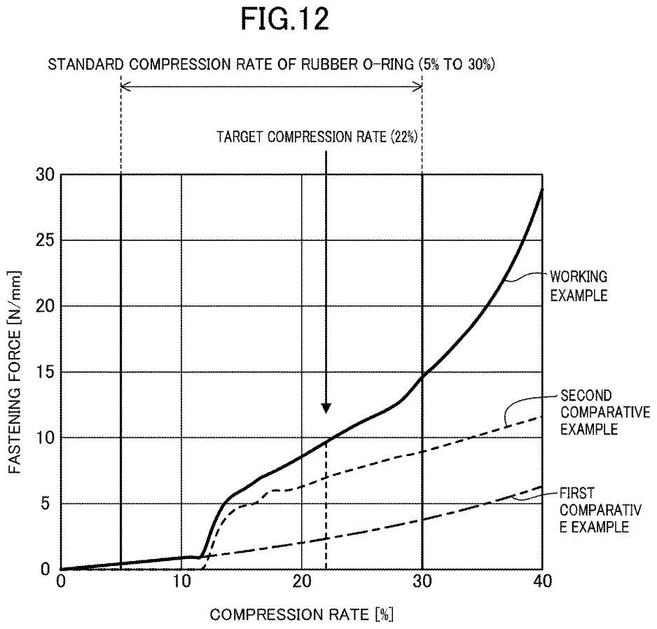

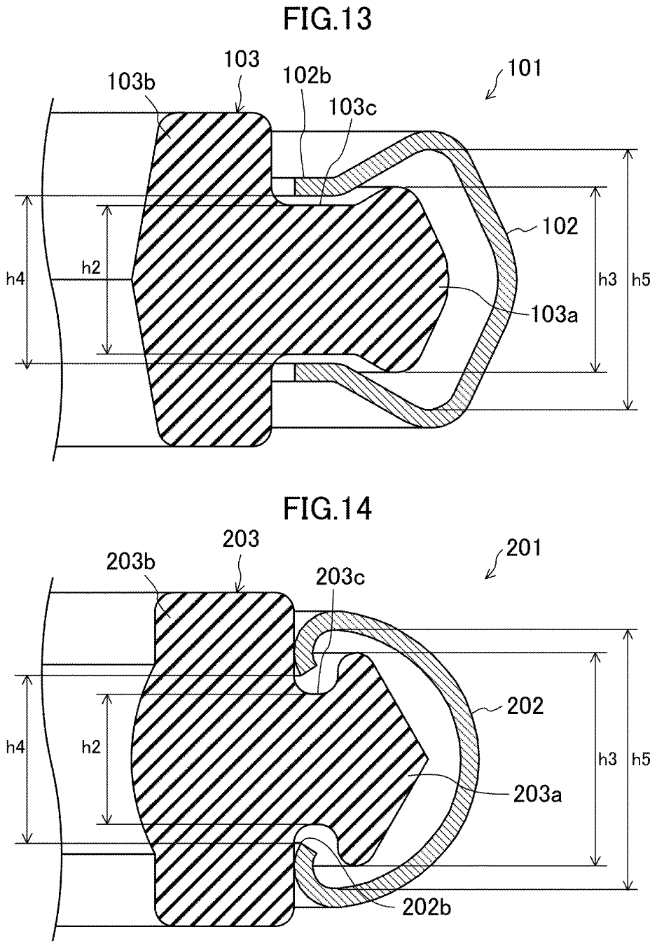

Since, as described above, the height h2 of the metal member 2′ when uncompressed is set lower than the height h1 of the elastomer member 3′ (h2<h1), as three lines given for a first comparative example where only the elastomer member 3′ was provided, for a second comparative example where only the metal member 2′ was provided, and for a working example where the composite seal unit l′ was provided indicate in FIG. 12, the metal member 2′ started contacting the pair of flanges 10′ and 11′ at around a compression rate of 13%. It can be seen that the fastening force of the composite seal unit l′ rapidly increased around there. On the other hand, the seal performance was ensured by the elastomer member 3′ from a start of compression.

That is, it is revealed that only upper and lower portions of the elastomer member 3′ contacted the pair of flanges 10′ and 11′ at first and, at around a compression rate of 13%, an outer periphery of the metal member 2′ also contacted the pair of flange portions 10′ and 11′.

The fastening force increased linearly at around a compression rate of 14%. It can be seen that, after 14%, both the metal member 2′ and the elastomer member 3′ were stably in contact with the pair of flanges 10′ and 11′ to exhibit the seal performance.

When a target fastening force was reached, the compression rate was about 22% and a largest fastening force was 9.3 N/mm.

### —Sealing Method by Composite Seal Unit—

As a seal structure of FIG. 10D is illustrated, the composite seal unit l′ described above is placed on the seal groove 12′ of the first flange portion 10′ and held between the pair of flange portions 10′ and 11′. Although there is no particular limitation on a device that is used, for example, the method is used for a portion of a semiconductor fabrication apparatus or a surface treatment apparatus for a liquid crystal panel that seals inside of a flow passage and outside of the flow passage in the pair of flange portions 10′ and 11′ that connect the flow passage of a gas or a liquid.

When uncompressed, only upper and lower projecting portions 3b′ of the elastomer member 3′ are caused to abut on the pair of flange portions 10′ and 11′. In the second embodiment, for example, the composite seal unit l′ is used where an outer peripheral side of the metal member 2′ (inside of the flow passage) is in a radical gas atmosphere and an inner peripheral side of the elastomer member 3′ (outside of the flow passage) is in an atmosphere of −80 °C or more and 250 °C or less. Since the projecting portions 3b′ of the elastomer member 3′ is in contact with the pair of flange portions 10′ and 11′ from a start of compression, the seal performance is reliably ensured.

Subsequently, when the compression rate is gradually increased, for example, as described above, the metal member 2′ also starts abutting on the pair of flange portions 10′ and 11′ at around a compression rate of 13%, and the projecting portions 3b′ and the deformed metal member 2′ contact the pair of flange portions 10′ and 11′ in a compressed state at a compression rate of 13% or more.

Thus, the composite seal unit l′ seals between the pair of flange portions 10′ and 11′ with a proper fastening force to reduce penetration of a gas from the elastomer member 3′ while suppressing flow of the radical gas to a side of the elastomer member 3′ by the metal member 2′.

The largest fastening force when compressed is preferably maintained, for example, at 3.44 N/mm or more and 20.0 N/mm or less. That is, the seal performance is secured by the flexible elastomer member 3′, and therefore, the largest fastening force can be maintained at a low value, as compared to a metal seal of a simple substance.

As described above, while, as ensuring the seal performance by the elastomer member 3′, suppressing flow of the radical gas to the side of the elastomer member 3′ by the metal member 2′ in contact with the pair of flange portions 10′ and 11′ in a compressed state, penetration of a gas from the elastomer member 3′ can be reduced and, since the elastomer member 3′ ensures the seal performance, the fastening force of the metal member 2′ can be reduced.

In the compressed state, since the metal member 2′ is in contact with the pair of flange portions 10′ and 11′ with a proper fastening force, flow of the radical gas to the side of the elastomer member 3′ is effectively suppressed and durability of the elastomer member 3′ is remarkably increased.

In the second embodiment, when an inner peripheral side of the elastomer member 3′ is in an atmosphere at −80 °C or more and 250 °C or less, but a seal with various physical properties (a temperature range, seal performance, or the like) can be realized by changing a material of the elastomer member 3′ as appropriate.

Furthermore, the recessed groove 2a′ of the metal member 2′ covers the fitting portion 3a′ of the elastomer member 3′ over an entire periphery, and thus, the fitting portion 3a′ is properly housed in the recessed groove 2a′ of the metal member 2′ to be less likely to be separated from the recessed groove 2a′ when uncompressed and when compressed.

Moreover, a cross-sectional shape of the metal member 2′ is curved such that the opening ends 2b′ are caused to be closer to each other and the opening ends 2b′ that are opposed to each other are engaged with the neck portion 3c′ of the elastomer member 3′ to prevent unintentional separation, so that handling in fitting the composite seal unit l′ to the seal groove 12′ or the like is extremely easy.

Therefore, according to the composite seal unit 1′ according to the second embodiment, the seal performance is maintained by the elastomer member 3′ and penetration of a gas from the elastomer member 3′ is reduced while suppressing flow of the corrosive gas or the radical gas to the side of the elastomer member 3′ by the metal member 2′, so that the seal performance can be increased while maintaining the fastening force low, separation can be caused to be less likely to occur, and handling can be facilitated.

### First Modified Example

FIG. 13 illustrates a composite seal unit 101 according to a first modified example of the second embodiment of the present disclosure, and the first modified example is different from the second embodiment specifically in that a metal member 102 has a different shape from the shape of the metal member 2. Note that, in each of the following modified examples, each component that is identical to a component illustrated in FIG. 9 to FIG. 11B is denoted by the same reference character as that used in FIG. 9 to FIG. 11B, and the detailed description thereof will be omitted.

The metal member 102 of this modified example is in a shape with a cross section like a cross section of a tea pot that is tapered toward a portion at an opening side obtained by press-machining a metal plate, not with an arc-shaped cross section. In this modified example, a pair of opening ends 102b are caused to be closer to each other in an approaching direction and a distance h4 between the opening ends 102b is smaller than the largest height h5 of the inner periphery of the recessed groove 2′ (h4<h5). A neck portion 103c may have a flat portion in accordance with a flat shape in which an inner diameter of the metal member 102 at the opening ends 102b is constant. A projecting portion 103b has a similar shape to that of the projecting portion 3b of the second embodiment described above. A space h4 between the opening ends 102b is smaller than a height h3 of a fitting portion 103a of an elastomer member 103 and is slightly larger than the height h2 of the neck portion 103c (h2<h4<h3<h5). By configuring the metal member 102 in the above-described manner, similar effects to those of the second embodiment can be achieved.

### Second Modified Example

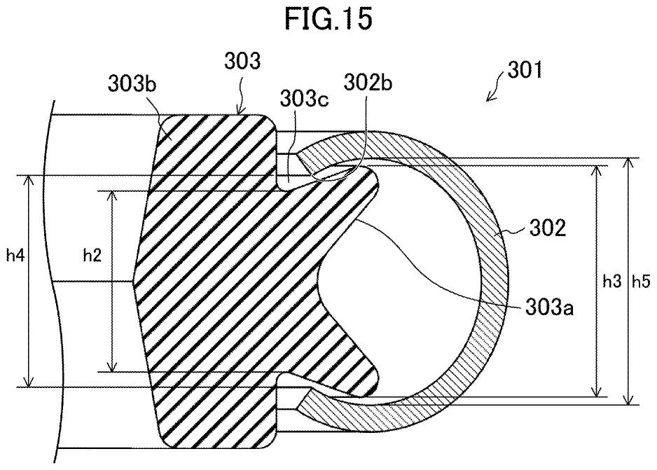

FIG. 14 illustrates a composite seal unit 201 according to a second modified example of the second embodiment of the present disclosure, and the second modified example is different from the second embodiment specifically in that a metal member 202 has a different shape from the shape of the metal member 2.

The metal member 202 of this modified example is in a shape with a substantially arc-shaped cross section but the metal member 202 is bent such that portions of the metal member 202 at both opening ends 202b are caused to be closer to each other in an up-down direction. A space h4 between the opening ends 202b is smaller than a height h3 of a fitting portion 203a and is slightly larger than a height h2 of a neck portion 203c (h2<h4<h3<h5). By configuring the metal member 202 in the above-described manner, similar effects to those of the second embodiment can be achieved.

Note that an inner peripheral surface of a projecting portion 203b of an elastomer member 203 in the radial direction is in a rounded shape. The neck portion 203c of the elastomer member 203 is in a shape in which a narrow portion that does not have a flat surface at each of upper and lower sides is small in width in the radial direction. in accordance with a shape of the opening ends 202b. However, there is no difference between the second modified example and the second embodiment in terms of effect.

### Third Modified Example

FIG. 15 illustrates a composite seal unit 301 according to a third modified example of the second embodiment of the present disclosure, and the third modified example is different from the second embodiment specifically in that an elastomer member 303 has a different shape from the shape of the elastomer member 3.

A metal member 302 of this modified example is, similar to the second embodiment, in a shape with an arc-shaped cross section, but the elastomer member 303 is in a shape with a dog-leg shaped cross section in which a recess is formed at an outer side in the radial direction. In this case, there is a relatively large gap between the elastomer member 303 and an inner surface of the metal member 302. A space h4 between opening ends 302b is smaller than a height h3 of a fitting portion 303a and is slightly larger than a height h2 of a neck portion 303c (h2<h4<h3<h5). By configuring the metal member 302 in the above-described manner, similar effects to those of the second embodiment can be achieved.

That is, in the second embodiment described above, the metal member 2′ is provided at an outer peripheral side but, when the inner peripheral side is under a radical gas environment or the like, the metal member 2′ is provided at the inner peripheral side. In this case, the elastomer member is fitted to the recessed groove from the outer peripheral side.

In the second embodiment described above, the first member and the second member are the pair of flange portions 10′ and 11′, but are not limited to a flange shape, and may be configured of a pair of members one of which includes a seal groove formed thereon.

Note that the embodiments described above are merely preferable examples by nature and are not intended to be particularly limiting the present disclosure, application of the present disclosure, and the scope of use.

What is claimed is:

1. A composite seal unit, comprising:
an annular metal member in which a continuous recessed groove is formed over an entire periphery at an outer peripheral side or an inner peripheral side; and
an elastomer member including a housed portion that is fitted to the recessed groove of the metal member and a projecting portion that continues with the housed portion and on which a pair of flange portions abut,
wherein
only the projecting portion abuts on the pair of flange portions when uncompressed and at start of compression,
the composite seal unit is configured such that, in a compressed state at a predetermined compression rate or more, the projecting portion and the deformed metal member contact the pair of flange portions to seal between the pair of flange portions, and
the recessed groove of the metal member covers the housed portion of the elastomer member over an entire periphery as both end portions thereof are caused to be closer to each other in an approaching direction and the housed portion is housed in the recessed groove to be less likely to be separated from the recessed groove when uncompressed and when compressed.

2. The composite seal unit of claim 1, wherein
the housed portion when uncompressed has a semicircular or semielliptic cross section or includes a groove having a V-shaped cross section.

3. The composite seal unit of claim 1, wherein
the metal member is curved or bent such that both opening ends of the recessed groove are caused to be closer to each other,
a fitting portion and the projecting portion continue with each other via a neck portion with a smaller thickness than that of the fitting portion,
a smallest distance between opposed portions of the opening ends of the metal member is smaller than a largest height of the fitting portion, and
the opening ends of the metal member are engaged with the neck portion over an entire periphery to prevent unintentional separation.

4. The composite seal unit of claim 3, wherein
in the compressed state, curved portions of the metal member at the opening ends abut on the pair of flange portions.

5. The composite seal unit of claim 3, wherein
the smallest distance between the opposed portions of the opening ends is equal to or larger than 70% of the largest height of the fitting portion and equal to or less than 99% of the largest height of the fitting portion.

6. A composite seal structure that exhibits seal performance in a state where the composite seal unit of claim 1 is fitted to a recessed groove of a first member and is clamped by a second member,
wherein
a largest height of the metal member
is larger than a depth of the recessed groove,
is smaller than a largest height of the projecting portion, and
is larger than 100% of the depth of the recessed groove and equal to or
smaller than 130% of the recessed groove.

7. The seal structure of claim 6, wherein
the largest height of the projecting portion is equal to or larger than 105% of the depth of the recessed groove and equal to or smaller than 145% of the depth of the recessed groove.

8. A sealing method by a composite seal unit,
the composite seal unit including
an annular metal member in which a continuous recessed groove is formed
over an entire periphery at an outer peripheral side or an inner peripheral side, and
an elastomer member including a housed portion that is fitted to the
recessed groove of the metal member and a projecting portion that continues with the
housed portion and on which a pair of flange portions abut,
the composite seal unit being configured such that
the recessed groove of the metal member covers the housed portion of the
elastomer member over an entire periphery,
the housed portion is held between the pair of flange portions in a state
where the housed portion is housed in the recessed groove to be less likely to be
separated from the recessed groove when uncompressed and when compressed,
only the projecting portion is caused to abut on the pair of flange portions
when uncompressed and at start of compression, and
in a compressed state at a predetermined compression rate or more, the
projecting portion and the deformed metal member are brought into contact with the
pair of flange portions to seal between the pair of flange portions and penetration of
a gas from the elastomer member is reduced while suppressing flow of a corrosive
gas or a radical gas to a side of the elastomer member by the metal member, and
the method comprising:
preparing the composite seal unit; and
molding the recessed groove of the metal member in advance such that, as both end portions thereof are caused to be closer to each other in an approaching direction, the housed portion is housed in the recessed groove to be less likely to be separated from the recessed groove when uncompressed and when compressed.

9. The sealing method of claim 8, wherein
a side of the metal member is in a radical gas atmosphere.

10. The sealing method of claim 8, wherein
a side of the elastomer member is used in an atmosphere of −80 °C or more and 250 °C or less.
